(19) United States
(12) Patent Application Publication
(10) Pub. No.: US 2023/0389748 A1
(43) Pub. Date: Dec. 7, 2023

(54) DUAL PURPOSE TEMPERATURE AND CONDUCTIVE PROBE FOR BEVERAGE MACHINE

(71) Applicant: Keurig Green Mountain, Inc., Burlington, MA (US)

(72) Inventors: Blair Mikkelsen, Chicago, IL (US); Matthew Martin Kenneth Hansen, Cambridge, MA (US); Jianming Huang, Andover, MA (US)

(73) Assignee: Keurig Green Mountain, Inc., Burlington, MA (US)

(21) Appl. No.: 18/033,446

(22) PCT Filed: Oct. 26, 2021
(86) PCT No.: PCT/US2021/056654

§ 371 Date: Apr. 24, 2023

Related U.S. Application Data
(60) Provisional application No. 63/106,801, filed on Oct. 28, 2020.

(51) Int. Cl. A47J 31/52; G01K 7/24; G01K 13/02; G01V 3/02; G01F 23/24; A47J 31/46; A47J 31/56; A47J 31/54; A47J 31/44

(52) U.S. Cl. CPC A47J 31/5253; G01K 7/24; G01K 13/026; G01V 3/02; G01F 23/241; A47J 31/468; A47J 31/56; A47J 31/545; A47J 31/4457; A47J 2202/00; A47J 2203/00

(57) ABSTRACT

Methods and systems for employing a sensor to detect two physical characteristics of a liquid in a beverage machine. A sensor may have a conductive probe portion to contact liquid, e.g., to detect a liquid level in a removable water tank, and a thermistor portion to detect a temperature of the liquid.

### CROSS REFERENCE TO RELATED APPLICATION

This application claims priority to U.S. Application No. 63/106,801, filed on Oct. 28, 2020, which is hereby incorporated by reference in its entirety.

### FIELD

This disclosure relates to beverage machines, such as coffee brewers that use a liquid to form a coffee beverage.

### BACKGROUND

Beverage machines frequently employ a temperature sensor to detect a temperature of water or other liquid, e.g., to help ensure that the liquid is suitably heated, cooled or otherwise at a desired temperature for beverage formation. As an example, some coffee brewers use a temperature sensor positioned to contact liquid in a heater tank to detect the temperature of liquid in the tank and to control a heater accordingly.

### SUMMARY

Temperature sensors used to detect liquid temperature are typically positioned so that the temperature sensor is always in contact with liquid. This positioning helps ensure that the temperature signal provided by the sensor to a beverage machine controller represents the temperature of liquid and not something else, such as air in the system. For example, heater tanks are often arranged so that the tank is never completely emptied of water even though water is delivered from the tank to form beverages. Thus, a temperature sensor in contact with liquid in the heater tank will always provide a signal indicative of the temperature of liquid in the tank.

The inventor(s) have appreciated that in some cases it is desirable to position a temperature sensor to determine a temperature of liquid at a location upstream of a heater. Such upstream positioning of the temperature sensor can allow a controller to control the heater according to the temperature of the incoming water, e.g., a heater may be operated at a higher heat output or a pump run at a slower flow rate for colder incoming water than for warmer incoming water. However, some beverage machines are configured so that liquid supply portions upstream of a heater may be empty of water in some circumstances, which can cause the temperature sensor to provide erroneous temperature information. For example, if a beverage machine includes a removable water tank that is removed during beverage formation, a supply line leading from the tank may be emptied of water. If a temperature sensor is positioned in the emptied supply line, the temperature sensor will indicate a temperature of air in the line rather than of liquid. For this reason, temperature sensors are generally located where liquid is sure to be present.

In some embodiments of this disclosure, a sensor is arranged to detect both a temperature and a presence/absence of liquid, e.g., in a liquid supply line. This can allow the positioning of the sensor in locations where the supply line may be emptied of liquid, e.g., whether on a controlled and/or unexpected basis, and yet still allow the sensor to provide accurate temperature information of a liquid. That is, since the sensor can be capable of detecting the presence/absence of liquid as well as temperature, the sensor can provide information regarding whether the liquid is present or not as well as a detected temperature. If liquid is present at the sensor, a reported temperature from the sensor will indicate a temperature of the liquid. If no liquid is present, the reported temperature will not necessarily be representative of a temperature of liquid, but rather something else, such as air in the supply line and/or the supply line itself. This inventive concept can be extended to other sensing arrangements, e.g., sensors arranged to detect two different physical characteristics of liquid other than temperature and presence/absence. As an example, a sensor can be arranged to detect pressure and presence/absence of liquid, allowing a controller to ensure that pressure information returned by the sensor is indicative of pressure in a liquid (or a gas).

According to one aspect, a beverage machine is provided. The beverage machine may include a liquid supply configured to provide liquid for use in forming a beverage. The beverage machine may also include a sensor arranged to detect two different physical characteristics of the liquid. The beverage machine may also include a controller coupled to the sensor and arranged to receive two different signals from the sensor indicative of the two different physical characteristics. The controller may be arranged to control at least a portion of the beverage machine based on the signals from the sensor component.

These and other aspects of the disclosure will be apparent from the following description and claims. It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 is a perspective view of a beverage machine in an illustrative embodiment;

FIG. 2 is schematic diagram of selected components of the beverage machine in an illustrative embodiment; and

FIG. 3 is a diagram of a sensor circuit in an illustrative embodiment.

### DETAILED DESCRIPTION

It should be understood that aspects of the disclosure are described herein with reference to certain illustrative embodiments and the figures. The illustrative embodiments described herein are not necessarily intended to show all aspects of the disclosure, but rather are used to describe a few illustrative embodiments. Thus, aspects of the disclosure are not intended to be construed narrowly in view of the illustrative embodiments. In addition, aspects of the disclosure may be used alone or in any suitable combination with other aspects of the disclosure.

Generally speaking, a beverage machine may be used to form any suitable beverage, such as tea, coffee, other infusion-type beverages, beverages formed from a liquid or powdered concentrate, soups, juices or other beverages made from dried materials, carbonated or uncarbonated beverages. The beverage machine can form such beverages using a base liquid, such as water, stored in a liquid supply tank. A beverage machine can be capable of forming a variety of beverages, each requiring a different amount of the base liquid. Thus, it may be desirable for a beverage machine to include features that allow the beverage machine to detect one or more physical characteristics of the liquid, e.g., detect a liquid level in the liquid supply tank, detect that liquid is available for use and/or is being provided to the machine components, detect a temperature of the liquid, etc. As discussed in more detail below, in some embodiments a beverage machine can include a sensor that detects both a temperature of liquid and a presence or absence of the liquid. This can allow a single sensor to provide useful information and confirm that temperature or other characteristic information is of the liquid.

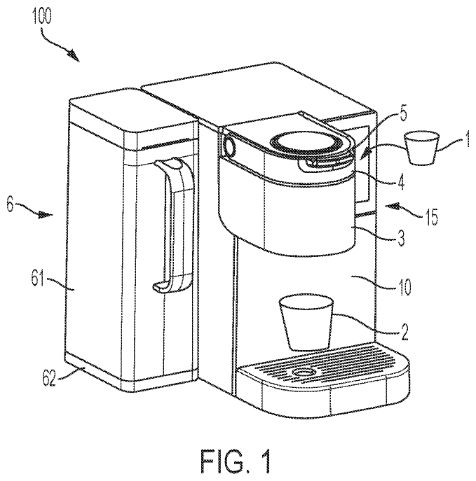

FIG. 1 shows a perspective view of a beverage machine 100 that incorporates features of this disclosure. In this illustrative embodiment, the machine 100 is arranged to form coffee or tea beverages. As is known in the art, a beverage cartridge 1 may be provided to the system 100 and used to form a beverage that is deposited into a user's cup or other suitable container 2. The cartridge 1 may be manually or automatically placed in a brew chamber of a beverage dispensing station 15 that in some embodiments includes a cartridge holder 3 and cover 4 of the beverage machine 100. For example, the holder 3 may be or include a circular, cup-shaped or otherwise suitably shaped opening in which the cartridge 1 may be placed. With a cartridge 1 placed in the cartridge holder 3, a handle 5 may be moved by hand (e.g., downwardly) so as to move the cover 4 to a closed position (as shown in FIG. 1). In the closed position, the cover 4 at least partially covers the cartridge 1, which is at least partially enclosed in a space in which the cartridge is used to make a beverage. For example, with the cartridge 1 held by the cartridge holder 3 in the closed position, water or other liquid may be provided to the cartridge 1 (e.g., by injecting the liquid into the cartridge interior) to form a beverage that exits the cartridge 1 and is provided to a cup 2 or other container. Of course, aspects of the disclosure may be employed with any suitably arranged system 100, including drip-type coffee brewers, carbonated beverage machines, and other systems that deliver water or other liquid to form a beverage. Thus, a cartridge 1 need not necessarily be used, but instead the beverage dispensing station 15 can accept loose coffee grounds or other beverage material to make a beverage. Also, the dispensing station 15 need not necessarily include a cartridge holder 3 and a cover 4. For example, dispensing station 15 can include a filter basket that is accessible to provide beverage material (such as loose coffee grounds), and the filter basket itself may be movable, e.g., by sliding engagement with the beverage machine 10 housing, and a cover 4 may be fixed in place. In other embodiments, the dispensing station 15 need not be user accessible, but instead beverage material may be automatically provided to, and removed from, the dispensing station 15. Moreover, the system 100 need not have a brew chamber, but instead other types of dispensing stations, e.g., that dispense hot and/or cold water (whether still or carbonated) at an outlet such as a dispensing nozzle without mixing with any beverage ingredient. Accordingly, a wide variety of different types and configurations for a dispensing station may be employed with aspects of this disclosure.

In some embodiments, the beverage machine 100 uses liquid, such as water, that is provided by a liquid supply 6 to form a beverage. In some embodiments, the liquid supply 6 can include a tank 61 arranged to hold water or other liquid. The tank 61 can be removably supported on a base 62, which fluidly couples to a port on a bottom of the tank 61 to receive and deliver liquid to other components of the machine 100, such as the dispensing station 15. A removable tank 61 can be convenient for a user because the user can remove the tank 61 from the base 62, e.g., by grasping a handle on the tank 61, for filling and then replace the tank 61 on the base 62. This is just one example, however, and a machine 100 can receive and/or store liquid in other ways. For example, the machine 100 can have a connection to a mains water supply (e.g., so-called “city water” or a line that delivers water under pressure to the machine 100), can have an internal or non-removable liquid supply tank or reservoir, or other.

In some embodiments, the machine 100 has one or more sensor components, and some of those components may detect characteristics of liquid in the liquid supply 6. As an example, the machine 100 can include a sensor component that contacts liquid in the liquid supply 6 to detect a presence or absence of liquid (e.g., to indicate a low water level in the tank 61), a temperature of water received from the tank 61, and/or other physical characteristics of the liquid. Such sensor components can be part of a sensor circuit that is electrically powered and used by a machine controller to detect the physical characteristics of the liquid and control the machine 100 accordingly. As an example, a controller can use a low water signal from a sensor circuit to provide an indication to a user that water needs to be added to the tank 61 and/or use a temperature signal from a sensor circuit to control a heater or other liquid conditioner (such as a chiller, carbonator, etc.).

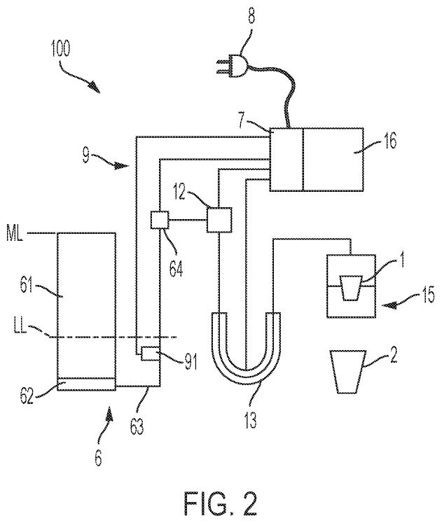

In some embodiments, for example, the beverage machine 100 can have a sensor component arranged to detect physical characteristics of the liquid in a supply line, such as the presence or absence of the liquid and/or a temperature of the liquid. FIG. 2 shows a schematic diagram of selected beverage machine 100 components in one embodiment that employs a sensor circuit 9 that has a sensor component 91 arranged to detect two different physical characteristics of liquid in the liquid supply 6. In this example, the sensor 91 includes a temperature component arranged to detect a temperature of liquid in a supply line 63 and a conductive probe arranged to contact liquid in the supply line 63. Thus, in some arrangements, the sensor 91 can include a first component that is electrically insulated from the liquid and arranged to detect a first physical characteristic of the liquid (e.g., the temperature component such as a thermistor arranged to detect temperature of the liquid), and a second component having an electrically conductive portion in contact with the liquid to detect a second physical characteristic of the liquid (e.g., to detect a presence and absence of the liquid). In some embodiments, the supply line 63 is fluidly coupled to the tank 61 (e.g., via a port at a bottom of the tank 61) and arranged to deliver liquid to a pump 12. The pump 12 can have an inlet fluidly coupled to the supply line 63 to receive liquid from the tank 61, and can deliver the liquid via an outlet to a heater 13 (or other liquid conditioner such as a chiller, carbonator, etc. that is fluidly coupled to the pump outlet), which heats (cools, carbonates, etc.) the liquid that is subsequently delivered to the dispensing station 15. In FIG. 2, the sensor 91 is shown between the tank 61 and the pump 12, but the sensor (or other additional sensors) can be located in other places, such as between the pump 12 and heater 13, downstream of the heater 13, etc.

In some embodiments, the sensor component 91 can detect the presence or absence of liquid in the supply line 63, and thereby provide an indication that another physical characteristic detected by the sensor component 91 (such as a temperature or pressure) is associated with the liquid rather than some other item. This can be useful, for example, where the sensor 91 is located in a part of the liquid supply 6 where liquid is not always present, and/or where the sensor 91 detects another characteristic, such as temperature that is used to control operation of a pump 12 and/or heater 13. In addition, the presence/absence of liquid signal provided by the sensor component 91 can provide an indication that the tank 61 is disconnected from the machine 100, has an exhausted liquid supply and/or that a liquid level in the tank 61 is below a threshold level. In the arrangement of FIG. 2, the supply line 63 is fluidly coupled to the bottom of the tank 61 and extends upwardly, e.g., above a maximum liquid level ML of the tank 61. Since the sensor component 91 is arranged in the supply line 63, this can allow the sensor component 91 to detect whether liquid is present at least at one location in the line 63, e.g., whether liquid is present in the line 63 above or below the sensor component 91 location. In some cases, the sensor component 91 can detect whether a liquid level LL of liquid in the supply line 63 is above or below a location of the sensor component 91 along the supply line 63. This can allow a determination of whether a liquid level LL in the tank 61 is below a threshold level, such as a minimum level required to dispense a beverage. In some embodiments, the supply line 63 can include a vent 64 arranged to vent the supply line 63 to atmospheric or other ambient pressure, e.g., the vent 64 can include an electrically-operated valve that a controller 16 can open to expose the supply line 63 to ambient pressure. In some cases, the vent 64 can be positioned above the maximum liquid level ML and/or above a position of the sensor component 91. Venting of the supply line 63 can allow the liquid level in the supply line 63 to correspond to, or be the same as, the liquid level LL in the tank 61. Thus, if the supply line 63 is vented and the sensor component 91 detects the presence of liquid, the controller 16 can determine that the liquid level LL in the tank 61 is above the position or height of the sensor component 91 (e.g., above a threshold level), and if the sensor component 91 does not detect the presence of liquid (i.e., detects the absence of liquid), the controller 16 can determine that the liquid level LL in the tank 61 is below the position or height of the sensor component 91 or that the tank 61 is disconnected from the supply line 63. (In some embodiments, the beverage machine need not include a valve for the vent 64. For example, the vent 64 can have a permanently open orifice or other opening of suitable size to always vent the supply line 63 to atmosphere. The vent 64 opening sized can be arranged relative to the pump capacity such that the pump can deliver liquid for beverage formation even though air may be drawn into the vent 64.)

In some embodiments, the pump 12 is located at or above the maximum liquid level ML of the tank 61 or at least downstream of the location of the sensor component 91 along the supply line 63. This arrangement can allow a determination whether liquid is being supplied to the pump 12 or not and can be useful to determine whether the tank 61 is disconnected from the machine 100 and/or a liquid supply in the tank 61 has been exhausted. For example, if the tank 61 is removed from the base 62 or runs out of liquid during operation of the pump 12 in drawing liquid from the tank 61, air will be drawn into the supply line 63 rather than liquid. When air reaches the sensor component 91, the sensor 91 can detect the absence of liquid and thus that the tank 61 has been removed or the liquid supply exhausted.

As will be understood from the above, the sensor 91 can be positioned in a liquid supply 6 in a location where liquid may not always be present, e.g., whether upstream or downstream of the pump 12 and/or in other locations. Thus, where the sensor 91 can detect the presence/absence of liquid and another characteristic of the liquid such as temperature, the sensor 91 can provide the controller 16 with information regarding not only whether liquid is present or absent at the sensor 91, but also whether the other detected characteristic is properly associated with the liquid or not. For example, if no liquid is detected at the sensor 91, then a detected temperature by the sensor 91 may not be of the liquid, but rather of the supply line 63, air or other item. The controller 16 can use signals from the sensor 91 regarding the two detected characteristics to control at least a portion of the beverage machine. As an example, the controller 16 may normally use liquid temperature sensed by the sensor 91 to control a heater 13, such as an inline heater or flash heater. Such inline heaters heat liquid relatively rapidly as the liquid passes through the heater 13, and so the incoming temperature of liquid can be useful to control a heating rate, output power or other characteristics of the heater 13 and/or to control a flow rate of liquid delivered by the pump 12 to the heater 13. As an example, colder incoming water may require use of a higher heating rate or power and/or a lower liquid flow rate than warmer incoming water. Where the sensor 91 is positioned upstream of the heater 13, the controller 16 can determine whether a sensed temperature is indicative of liquid delivered to the heater 13 or not, and this information can be used to control the heater 13, the pump 12 and/or other components. For example, in some embodiments, the controller 16 can be arranged to control the vent 64 and pump 12 to deliver air to the heater 13 so that the air can be heated and delivered to dispensing station 15 (e.g., to pre-heat the station 15 prior to dispensing a hot beverage. This can be done by opening the vent 64 and operating the pump 12 so only air is pumped to the heater 13 and dispensing station 15.). Heating air may require a lower heating rate or output power than heating water and so the controller 16 may control the heater accordingly. Subsequently, the controller can control the vent 64 and pump 12 to deliver liquid from the tank 61 to the heater 13 for heating and delivery to the dispensing station 15 (e.g., by closing the vent 64 and operating the pump 12 to draw liquid from the tank 61 and deliver the liquid to the heater 13). The sensor 91, which may be positioned between the vent 64 and the pump 12 or between the pump 12 and heater 13 in this example, can be used to detect temperature of air or water, as well as determine whether and when liquid is being delivered to the heater 13.

The controller 16 can control various components of the beverage machine 100 in different ways based on signals from the sensor 91 regarding the two detected physical characteristics. In some embodiments, the controller 16 can provide an indication to the user to add liquid to the tank 61 as well as shut down or reduce a heating rate of the heater 13 if the sensor 91 detects the absence of liquid. The sensor 91 can also provide an indication that the tank 61 is removed from the machine 100 if the sensor 91 detects the absence of liquid while the pump 12 is drawing water from the tank 61. That is, if the tank 61 is removed as the pump 12 is pulling liquid from the supply line 63, liquid will no longer be provided to the inlet side of the supply line 63 and the pump 12 will empty the supply line 63. Once liquid is drawn past the sensor component 91, the sensor component 91 will no longer detect liquid, indicating that the tank 61 has been removed. In this case, the controller 16 can provide an indication to the user to replace the tank 61, stop pump and heater operation, etc.

In some embodiments, the sensor 91 can be part of a sensor circuit 9 that is electrically powered by a non-isolated power supply 7 that receives input electrical power via a mains power connection 8 (such as a plug arranged to connect with a wall outlet or other power source) and conditions the input power to provide output power to the sensor circuit 9. The input electrical power to the power supply 7 can be arranged in various ways, but in general will be at a higher voltage than that used by the sensor circuit 9 and other components of the machine 100. As an example, the input electrical power can be about 120 Volts AC as provided within some residences. The non-isolated power supply 7 can be arranged to reduce the voltage of the input electrical power, e.g., to 12 Volts AC, and to convert the input electrical power to direct current, e.g., 12 Volt AC can be converted to 12 Volt DC. The non-isolated power supply 7 can use a plurality of impedances (e.g., resistors) to reduce the voltage of the input electrical power, and a voltage converter to convert the 12 Volt AC to 12 Volt DC. The non-isolated power supply 7 can also include a voltage regulator or other component to reduce the voltage of the converted DC power, e.g., to reduce the 12 Volt DC to 3.3 Volts DC. The 3.3 Volt DC output electrical power can be used to power the sensor circuit 9 as well as other components of the machine 100, such as parts of the controller 16. Similarly, the 12 Volt DC power can be used to power other components, such as the pump 12 and/or parts of the controller 16. In some cases, some components such as the heater 13 can be powered by unmodified input power, e.g., the input electrical power can be selectively directly connected to the heater 13 using relay switches or other components controlled by the controller 16. These are only illustrative embodiments, however, and the non-isolated power supply 7 can be arranged to produce other voltage levels using any suitable components. Regardless, the non-isolated power supply 7 employs a common ground or circuit neutral for input and output power. Note as well that the machine 100 can employ other types of power supplies than a non-isolated power supply, such as isolated power supplies, to power beverage machine components including the sensor circuit 9.

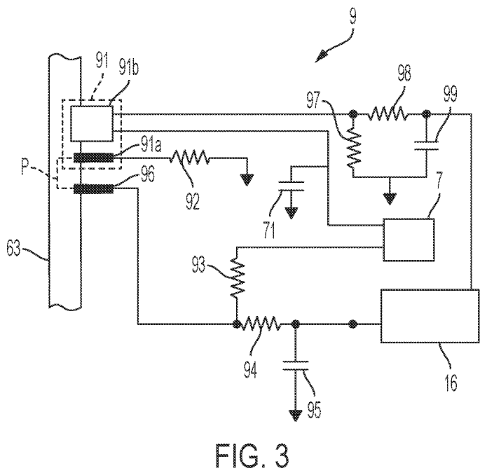

FIG. 3 shows an illustrative embodiment of a sensor circuit 9 including a sensor component 91 that can be employed in the FIG. 2 arrangement or others. In this example, the sensor 91 includes a first conductive probe 91a that is arranged to contact liquid in the liquid supply line 63, e.g., to detect a presence or absence of liquid. The sensor 91 also includes a temperature component, such as a thermistor, 91b arranged to detect a temperature in the supply line 63. Unlike the first conductive probe 91a, the temperature component 91b can be electrically insulated from any liquid in the supply line 63. The first conductive probe 91a and the temperature component 91b can be fixed together as a single, integral part, e.g., the first conductive probe 91a can be arranged as a metallic tube with a closed end positioned within the supply line 63 and an open end positioned outside of the supply line 63. The temperature component 91b can be inserted into the open end of the metallic tube so that the temperature component 91b is positioned at the closed end of the tube. This can allow the temperature component 91b to avoid contact with liquid but be thermally coupled to the liquid in the supply line 63 via the metallic tube. In some embodiments, to detect the presence/absence of liquid, the sensor circuit 9 can include a second conductive probe 96 that can contact liquid in the supply line 63. The second conductive probe 96 can be physically separate from the sensor 91. The conductive probes 91a, 96 are electrically insulated from each other except for a path P through liquid present between the conductive probes 91a, 96 (represented by the dashed line in FIG. 3). Thus, if water or other liquid is present between the conductive probes 91a, 96, a conductive path is established between the conductive probes 91a, 96 but no conductive path is present if liquid is not present between the conductive probes 91a, 96. This allows the sensor component 91 to detect the presence or absence of liquid in this embodiment.

In some embodiments, the second conductive probe 96 is connected to output electrical power of the non-isolated power supply 7, e.g., a 3.3 Volts DC power supply, via a power supply impedance 93. In some embodiments, the power supply impedance 93 has a resistance of about 1M Ohm, although other resistance values can be used and can be provided by one or more resistance elements. This power supply impedance 93 can prevent or limit current introduced into the liquid by the sensor circuit 9 to low levels, e.g., 2 milliamps or less, even in the case of some types of component failures. The first conductive probe 91a is connected to electrical ground or circuit neutral (represented by the downwardly pointed arrowhead) via a protective impedance 92. The protective impedance 92 helps prevent the sensor circuit 9 from introducing electrical current into the liquid that could expose a user to dangerous electrical shocks, e.g., if undesirable voltage/current is introduced into the circuit ground or neutral path connected to the first conductive probe 91a and the user contacts the beverage liquid during dispensing. In some embodiments, the sensor circuit including the protective impedance 92 can be configured to limit a maximum possible current delivered or deliverable by the sensor circuit to the liquid to be less than 2 milliamps or less, e.g., no more than 0.5 milliamps or 0.7 milliamps. Such a maximum possible current limit can be provided for both AC and DC, and for frequencies up to 1 kHz and voltages up to 450 Volts, e.g., in case there is a short circuit or other failure in the non-isolated power supply 7 or elsewhere. In some embodiments, the protective impedance 92 has a resistance of 1 k Ohms but other values may be used as suitable.

The controller 16 is coupled to the liquid presence/absence detection portion of the sensor circuit 9 via a connection to the second conductive probe 96. As can be seen in FIG. 3, the controller 16 is coupled to the output side of the power supply impedance 93 via a sensor impedance 94. A capacitor 95 is also connected to the input side of the sensor impedance 94 and is connected to electrical ground or circuit neutral. In some embodiments, the sensor impedance 94 has a resistance of 1 k Ohms and the capacitor 95 has a capacitance of 100 nanofarads, although other resistance and/or capacitance values can be employed as suitable. Coupling of the controller 16 to the second conductive probe 96 in this way allows the controller 16 to detect a voltage at the second conductive probe 96 (or at least a value representative of such voltage), and thus the presence and absence of liquid at the sensor component 91. In other words, coupling of the controller 16 to the liquid presence/absence detection portion of the sensor circuit 9 allows the controller 16 to receive a signal from the sensor circuit 9 indicative of a physical characteristic of the liquid that is detected by the sensor component 91, e.g., the presence or absence of liquid. In some embodiments, a voltage at the second conductive probe 96 at a low level indicates the presence of liquid at the sensor component 91, e.g., because the liquid provides a conductive path between the probes 91a, 96 to circuit ground or neutral. A voltage at the second conductive probe 96 at a high level (which is higher than the low level), indicates the absence of liquid at the first and second conductive probes 91a, 96. As an example, the high level voltage can be approximately 3.3 Volts DC (i.e., the voltage provided to the sensor circuit 9 by the non-isolated power supply 7), and the low level voltage can be 0.3 Volts or less. (The liquid presence/absence portion of the sensor circuit 9 could be changed so the controller 16 is connected to the first conductive probe 91a rather than the second conductive probe 96. In this case, the second conductive probe 96 can be connected to electrical ground or circuit neutral via the protective impedance 92.)

The controller 16 is also connected to a temperature sensing portion of the sensor circuit 9. In some embodiments, a first lead of the temperature component 91b (e.g., a thermistor) is connected to a power output of the power supply 7 along with a capacitor 71 which has one end connected to circuit neutral or ground. A second lead of the temperature component 91b is connected to the controller 16 via a pair of resistors 97, 98 and a capacitor 99 as shown in FIG. 3. This allows the controller 16 to receive a signal from the sensor 91 that is indicative of a temperature at the supply line 63, e.g., of liquid in the supply line 63 where liquid is present. It will be understood that the circuit arrangement in FIG. 3 is only one example, and that any suitable circuitry can be used to power the circuit (as needed) and provide suitable signals to the controller 16 regarding detected characteristics.

While the sensor component 91 in the FIG. 3 embodiment includes at least one conductive element that contacts the liquid to detect the presence or absence of liquid and a temperature component to detect temperature, the sensor component 91 can be arranged in different ways and/or to detect other physical characteristics of the liquid. For example, the sensor component 91 can include a sensor arrangement to detect pressure, conductivity, salinity, turbidity and/or other characteristic of the liquid, etc. In some embodiments, the sensor component 91 can detect three or more characteristics of the liquid, such as temperature, conductivity and presence/absence. (Additional sensor circuit 9 components would likely be required to allow for sensing multiple characteristics.)

To initiate a beverage cycle, a user may first insert a cartridge 1 into the dispensing station 15 and provide an indication (e.g., by pressing a button or other suitable step) to beverage machine 100 to prepare a beverage. At or before this time, the controller 16 can monitor the sensor circuit 9 to assess whether liquid is present at the sensor component 91 or not and/or a temperature at the sensor 9. If the supply line 63 is provided with a controllable vent 64, the controller 16 can open the vent valve 64 to help ensure that the liquid level in the supply line 63 is equal to the liquid level in the tank 61. If no liquid is detected, the controller 16 can stop beverage formation and provide an indication to the user, e.g., via a user interface on the housing 10, that water or other liquid must be added and/or the tank 61 replaced. If liquid is detected, the controller 16 can proceed with beverage formation, e.g., including closing the vent 64, operating the pump 12 to deliver liquid to the heater 13. A temperature of the incoming liquid detected by the sensor 91 can be used by the controller 16 to control the heater 13 and/or pump 12. As an example, a power output of the heater 13 and/or a flow rate of the pump 12 can be adjusted to compensate for different incoming liquid temperatures. During pump 12 operation, the controller 16 can monitor the sensor circuit 9 for the absence of liquid. If an absence of liquid is detected, the controller 16 can stop pump operation, heating and/or other functions, e.g., because the tank 61 may have been removed and/or a liquid supply in the tank 61 exhausted. The controller 16 can provide an indication to a user via the user interface that the tank 61 should be replaced to begin or restart beverage dispensing.

As noted above, operation of the pump 12, heater 13 and other components of the machine 100 may be controlled by the controller 16, which may include a programmed processor and/or other data processing device along with suitable software or other operating instructions, one or more memories (including non-transient storage media that may store software and/or other operating instructions), temperature and liquid level sensors, pressure sensors, input/output interfaces (such as a user interface on the housing 10), communication buses or other links, a display, switches, relays, triacs, or other components necessary to perform desired input/output or other functions. A user interface may be arranged in any suitable way and include any suitable components to provide information to a user and/or receive information from a user, such as buttons, a touch screen, a voice command module (including a microphone to receive audio information from a user and suitable software to interpret the audio information as a voice command), a visual display, one or more indicator lights, a speaker, and so on.

While aspects of the disclosure may be used with any suitable cartridge, or no cartridge at all, some cartridges may include features that enhance the operation of a beverage machine 100. As is known in the art, the cartridge 1 may take any suitable form such as those commonly known as a sachet, pod, capsule, container or other. For example, the cartridge 1 may include an impermeable outer covering within which is housed a beverage medium, such as roasted and ground coffee or other. The cartridge 1 may also include a filter so that a beverage formed by interaction of the liquid with the beverage medium passes through the filter before being dispensed into a container 2. As will be understood by those of skill in the art, cartridges in the form of a pod having opposed layers of permeable filter paper encapsulating a beverage material may use the outer portion of the cartridge 1 to filter the beverage formed. The cartridge 1 in this example may be used in a beverage machine to form any suitable beverage such as tea, coffee, other infusion-type beverages, beverages formed from a liquid or powdered concentrate, etc. Thus, the cartridge 1 may contain any suitable beverage material, e.g., ground coffee, tea leaves, dry herbal tea, powdered beverage concentrate, dried fruit extract or powder, powdered or liquid concentrated bouillon or other soup, powdered or liquid medicinal materials (such as powdered vitamins, drugs or other pharmaceuticals, nutriaceuticals, etc.), and/or other beverage-making material (such as powdered milk or other creamers, sweeteners, thickeners, flavorings, and so on). In one illustrative embodiment, the cartridge 1 contains a beverage material that is configured for use with a machine that forms coffee and/or tea beverages, however, aspects of the disclosure are not limited in this respect.

Also, the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

As used herein, “beverage” refers to a liquid substance intended for drinking that is formed when a liquid interacts with a beverage material, or a liquid that is dispensed without interacting with a beverage material. Thus, beverage refers to a liquid that is ready for consumption, e.g., is dispensed into a cup and ready for drinking, as well as a liquid that will undergo other processes or treatments, such as filtering or the addition of flavorings, creamer, sweeteners, another beverage, etc., before being consumed.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

1. A beverage machine comprising:
a liquid supply configured to provide liquid for use in forming a beverage;
a sensor arranged to detect two different physical characteristics of the liquid; and
a controller coupled to the sensor and arranged to receive two different signals from the sensor indicative of the two different physical characteristics,
wherein the controller is arranged to control at least a portion of the beverage machine based on the signals from the sensor.

2. The machine of claim 1, wherein the sensor includes a temperature component arranged to detect a temperature of the liquid, and a conductive probe arranged to contact the liquid to detect a presence and absence of the liquid.

3. The machine of claim 2, wherein the temperature component includes a thermistor.

4. The machine of claim 2, further comprising a heater, and wherein the controller is arranged to control the heater based on a temperature signal from the temperature component.

5. The machine of claim 4, wherein the temperature component is arranged to detect the temperature of the liquid before the liquid is provided to the heater for heating.

6. The machine of claim 5, wherein the heater is an inline heater.

7. The machine of claim 2, further comprising a liquid supply tank, and wherein the conductive probe is arranged to detect whether a liquid level in the liquid supply tank is above or below a threshold level.

8. The machine of claim 2, further comprising a liquid supply tank that is removable from the beverage machine, and wherein the conductive probe is arranged to detect whether the liquid supply tank is removed from the beverage machine during beverage dispensing.

9. The machine of claim 1, further comprising a liquid supply tank, and wherein the sensor includes a conductive probe arranged to detect whether a liquid level in the liquid supply tank is above or below a threshold level.

10. The machine of claim 9, further comprising a supply line fluidly coupled to receive liquid from the liquid supply tank, and wherein the conductive probe is arranged to contact liquid in the supply line.

11. The machine of claim 10, further comprising a pump having an inlet fluidly coupled to the supply line to receive liquid from the liquid supply tank, and wherein the sensor is arranged on the supply line between the liquid supply tank and the pump.

12. The machine of claim 11, further comprising a heater arranged to receive liquid from the pump, wherein the sensor includes a temperature component to detect a temperature of liquid in the supply line, and the controller is arranged to control the heater based on the temperature.

13. The machine of claim 1, further comprising a liquid supply tank and a supply line fluidly coupled to receive liquid from the liquid supply tank, and wherein the sensor includes a conductive probe arranged to detect a presence or absence of liquid in the supply line.

14. The machine of claim 13, wherein the conductive probe is arranged to detect whether a liquid level in the liquid supply tank is above or below a threshold level.

15. The machine of claim 13, wherein the conductive probe is arranged to detect whether the liquid supply tank is removed from the beverage machine during beverage dispensing.

16. The machine of claim 13, further comprising a pump having an inlet fluidly coupled to the supply line to receive liquid from the liquid supply tank, and wherein the sensor is arranged on the supply line between the liquid supply tank and the pump.

17. The machine of claim 16, further comprising a heater arranged to receive liquid from the pump, wherein the sensor includes a temperature component to detect a temperature of liquid in the supply line, and the controller is arranged to control the heater based on the temperature.

18. The machine of claim 13, wherein the conductive probe is a first conductive probe, the machine further comprising a second conductive probe separate from the sensor and arranged to contact the liquid in the supply line at a location spaced from the first conductive probe, and wherein the first and second conductive probes are part of a sensor circuit to detect the presence or absence of liquid in the supply line.

19. The machine of claim 1, wherein the two different physical characteristics include two of the following: a presence of the liquid, a pressure of the liquid, a temperature of the liquid, a conductivity of the liquid, a salinity of the liquid, and a turbidity of the liquid.

20. The machine of claim 1, wherein sensor includes a first component electrically insulated from the liquid and arranged to detect a first physical characteristic of the liquid, and a second component having an electrically conductive portion in contact with the liquid to detect a presence and absence of the liquid.
